(19) United States
(12) Patent Application Publication
(10) Pub. No.: US 2012/0208536 A1
(43) Pub. Date: Aug. 16, 2012

(54) APPARATUS AND METHOD FOR PERFORMING CELL RESELECTION IN PORTABLE TERMINAL

(75) Inventors: Soon-Hyun Cha, Anyang-si (KR); Seung-Wook Hong, Hwaseong-si (KR)

(73) Assignee: SAMSUNG ELECTRONICS CO., LTD., Suwon-si (KR)

(21) Appl. No.: 13/398,352

(22) Filed: Feb. 16, 2012

(30) Foreign Application Priority Data
Feb. 16, 2011 (KR) 10-2011-0013588

(51) Int. Cl. H04W 24/00; H04W 36/00

(52) U.S. Cl. 455/434

(57) ABSTRACT

An apparatus and method for ascertaining a movement pattern of a user who moves on a fixed path, predicting a destination cell on the movement of the user, and preventing a cell reselection process to an unnecessary intermediate cell. The apparatus includes a pattern management unit configured to analyze movement of a user and ascertain a movement pattern of the user. The apparatus also includes a memory configured to store the movement pattern of the user, which is ascertained by the pattern management unit. The apparatus also includes a controller configured to ascertain information about a destination cell and information about an intermediate cell through which the user passes before moving to the destination cell using the movement pattern of the user and a current movement path of the portable terminal. The apparatus also includes a cell reselection unit for performing a cell reselection process to the destination cell.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on Feb. 16, 2011 and assigned Serial No. 10-2011-0013588, the entire disclosure of which is hereby incorporated by reference.

### TECHNICAL FIELD

The present disclosure relates to a cell reselection process of a portable terminal. More particularly, the present disclosure relates to an apparatus and method for ascertaining a movement pattern of a user who moves on a fixed path, predicting a destination cell on the movement of the user, and preventing a cell reselection process to an unnecessary intermediate cell.

### BACKGROUND

In general, if the power of a portable terminal is turned on, the terminal searches cells of a Public Land Mobile Network (PLMN), selects a cell, connects to a communication network of the selected cell, and adjusts a channel.

If the aforementioned portable terminal moves between cells in a power-on state, the terminal searches a new cell which provides a better signal than that of a serving cell from neighbor cells and performs a cell reselection process.

The cell reselection process of the portable terminal is a process of selecting a cell with better conditions than those of the serving cell based on radio wave measurement and cell reselection criteria of an idle state. The cell reselection process of the portable terminal allows the portable terminal to reselect a peripheral cell with satisfied cell reselection criteria among suitable cells.

That is, if the portable terminal does not receive a service from a serving cell which exists currently or if the portable terminal discovers a better cell than a current serving cell, the portable terminal performs a cell reselection process to a neighbor cell to maintain a smooth service.

The cell reselection process is performed based on the cell reselection criteria. In some situations, the portable terminal performs an unnecessary cell reselection process. For example, when a path on which the user of the portable terminal moves frequently is from a cell A to a cell C through a cell B, that is cell A→cell B→cell C, cell B may be a place through which the user passes to move to cell C which is a destination cell. If the user of the portable terminal moves on the aforementioned path when the user goes to work, the portable terminal performs a cell reselection process from cell A to cell B and performs a cell reselection process from cell B to cell C. If cells B and C are included on a neighbor cell list in a state where the portable terminal is positioned in cell A, a cell reselection process to cell B may be unnecessary. For this reason, there is a problem in that power consumption of the portable terminal may occur due to the unnecessary cell reselection process.

Accordingly, in order to solve the problem, an apparatus and method for analyzing a movement pattern of a user and preventing a cell reselection process to an unnecessary cell in a portable terminal is needed.

### SUMMARY

To address the above-discussed deficiencies of the prior art, it is a primary object to provide at least the advantages described below. Accordingly, an aspect of the present disclosure is to provide an apparatus and method for improving performance of a cell reselection process in a portable terminal.

Another aspect of the present disclosure is to provide an apparatus and method for preventing a cell reselection process to an unnecessary cell in a portable terminal.

Another aspect of the present disclosure is to provide an apparatus and method for analyzing a movement pattern of a user and ascertaining information about a destination cell and information of a cell through which the user passes before moving to the destination cell in a portable terminal.

Another aspect of the present disclosure is to provide an apparatus and method for preventing cell reselection to an unnecessary cell and reducing power consumption in a portable terminal.

In accordance with an aspect of the present disclosure, an apparatus for performing cell reselection in a portable terminal is provided. The apparatus includes a pattern management unit configured to analyze movement of a user and ascertain a movement pattern of the user. The apparatus also includes a memory configured to store the movement pattern of the user, which is ascertained by the pattern management unit. The apparatus further includes a controller configured to ascertain information about a destination cell and information about an intermediate cell through which the user passes before moving to the destination cell using the movement pattern of the user and a current movement path of the portable terminal. The apparatus still further includes a cell reselection unit configured to perform a cell reselection process to the destination cell, wherein the controller applies a weight to a cell reselection parameter to prevent cell reselection to the intermediate cell and performs the cell reselection process to the destination cell.

In accordance with another aspect of the present disclosure, a method of performing cell reselection in a portable terminal is provided. The method includes analyzing movement of a user and ascertaining a movement pattern of the user. The method also includes storing the ascertained movement pattern of the user. The method further includes ascertaining information about a destination cell and information about an intermediate cell through which the user passes before moving to the destination cell using the movement pattern of the user and a current movement path of the portable terminal. The method still further includes performing a cell reselection process to the destination cell, wherein the performance of the cell reselection process to the destination cell comprises applying a weight to a cell reselection parameter to prevent cell reselection to the intermediate cell.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a structure of a portable terminal for preventing a cell reselection process to an unnecessary cell according to the present disclosure;

FIG. 2 illustrates a process of registering a movement pattern of a user in a portable terminal according to the present disclosure;

FIG. 3 illustrates a process of ascertaining a movement pattern of a user in a portable terminal according to the present disclosure;

FIG. 4 illustrates a cell reselection process of a portable terminal according to the present disclosure;

FIG. 5 illustrates a process of registering a movement pattern of a user in a portable terminal according to one embodiment of the present disclosure; and

FIG. 6 illustrates a process of performing cell reselection to a destination cell without passing through an unnecessary intermediate cell in a portable terminal according to one embodiment of the present disclosure.

Throughout the drawings, like reference numerals will be understood to refer to like parts, components and structures.

### DETAILED DESCRIPTION OF THE INVENTION

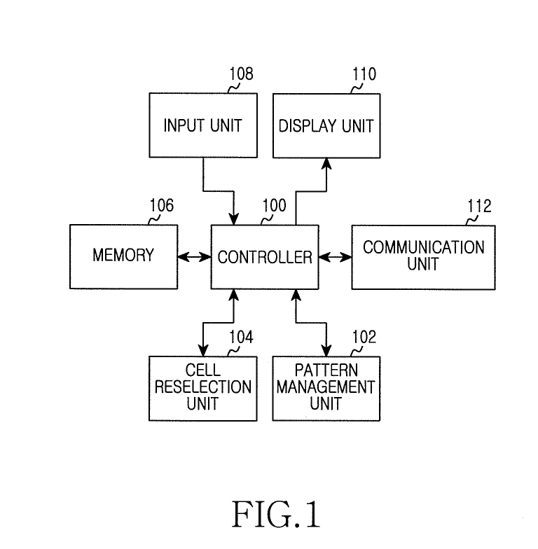

FIGS. 1 through 6, discussed below, and the various embodiments used to describe the principles of the present disclosure in this patent document are by way of illustration only and should not be construed in any way to limit the scope of the disclosure.

Exemplary embodiments of the present disclosure will be described herein below with reference to the accompanying drawings. In the following description, well-known functions or constructions are not described in detail since they would obscure the disclosure in unnecessary detail.

Hereinafter, a description will be given with respect to an apparatus and method for analyzing a movement pattern of a user, ascertaining information about a destination cell and information of a cell through which the user passes before moving to the destination cell, and preventing cell reselection to an unnecessary cell to reduce power consumption in a portable terminal according to the present disclosure.

FIG. 1 illustrates a structure of a portable terminal for preventing a cell reselection process to an unnecessary cell according to an embodiment of the present disclosure.

Referring to FIG. 1, the portable terminal may include a controller 100, a pattern management unit 102, a cell reselection unit 104, a memory 106, an input unit 108, a display unit 110, and a communication unit 112.

The controller 100 of the portable terminal controls an overall operation of the portable terminal. For example, the controller 100 processes and controls voice telephone call and data communication. In addition to normal functions, the controller 100 prevents a cell reselection process to an unnecessary cell to reduce power consumption of the portable terminal according to the present disclosure.

That is, the controller 100 verifies information about a cell to which a user of the portable terminal moves and analyzes and stores a movement pattern of the user.

Also, when the controller 100 ascertains that a movement pattern of the user, which is similar to a path on which the user moves, is stored, the controller 100 ascertains information about a destination cell to which the user will move and information about an intermediate cell through which the user passes before moving to the destination cell. The controller 100 omits a cell reselection process to the intermediate cell and performs cell reselection to the destination cell immediately. Herein, the intermediate cell is a cell through which the user passes briefly among cells to which the user moves and means a cell in which a cell reselection process is unnecessary.

That is, the controller 100 applies weights to cell reselection parameters for the destination cell and the intermediate cell, omits the cell reselection process to the intermediate cell, and performs the cell reselection to the destination cell immediately.

The pattern management unit 102 senses movement of the user of the portable terminal, registers a movement pattern of the user, compares a previously stored movement pattern of the user with a current movement path of the portable terminal, and predicts a path on which the user will move. That is, the pattern management unit 102 predicts the destination cell and the intermediate cell using the movement pattern of the user and provides the predicted information to the controller 100.

Also, the pattern management unit 102 ascertains whether to store the movement pattern of the user, corresponding to current movement of the portable terminal under control of the controller 100, and provides the ascertained information to the controller 100.

The cell reselection unit 104 performs a cell reselection process to a cell which satisfies cell reselection criteria under control of the controller 100. That is, the cell reselection unit 104 performs the cell reselection process of camping to the destination cell instead of camping to the intermediate cell according to control of the controller 100.

The memory 106 of the portable terminal includes a Read Only Memory (ROM), a Random Access Memory (RAM), and a flash ROM. The ROM stores a microcode of a program, by which the controller 100, the pattern management unit 102, and the cell reselection unit 104 are processed and controlled, and a variety of reference data.

The RAM is a working memory of the controller 100 and stores temporary data that is generated while a variety of programs are performed. The flash ROM stores a variety of rewritable data, such as phonebooks, outgoing messages, incoming messages, and information of touch input points of the user. In addition, the memory 106 stores the movement pattern of the user, which is ascertained by the pattern management unit 102 according to the present disclosure.

The input unit 108 includes numeral key buttons of ‘0’ to ‘9’ and a plurality of function keys such as a menu button, a cancel button, an OK button, a talk button, an end button, an Internet access button, a navigation key (or directional key) button, and a character input key. The input unit 108 provides key input data corresponding to a key pushed by the user to the controller 100.

The display unit 110 displays state information which is generated while the portable terminal is operated, a number of characters, moving and still pictures, and so forth. The display unit 110 may be a color Liquid Crystal Display (LCD), an Active Matrix Organic Light Emitting Diode (AMOLED), and the like. The display unit 110 includes a touch input device. When the display unit 110 is applied to a touch input type portable terminal, it may be used as an input device.

The communication unit 112 transmits and receives a Radio Frequency (RF) signal of data which is input and output through an antenna (not illustrated). For example, in a transmitting process, data to be transmitted is subject to a channel-coding process and a spreading process, and then the data is transformed to an RF signal. In a receiving process, the RF signal is received and transformed to a baseband signal, and the base-band signal is subject to a de-spreading process and a channel-decoding process, thereby restoring the data.

The functions of the pattern management unit 102 and the cell reselection unit 104 may be performed by the controller 100 of the portable terminal. However, the present disclosure includes the controller 100, the pattern management unit 102, and the cell reselection unit 104, which are exemplary configurations for the convenience of explanation and are not limited to a scope of the prevent disclosure. It will be understood by those skilled in the art that various changes in form and details may be made therein without departing from the spirit and scope of the present disclosure. For example, all of the functions described above may be processed in the controller 100.

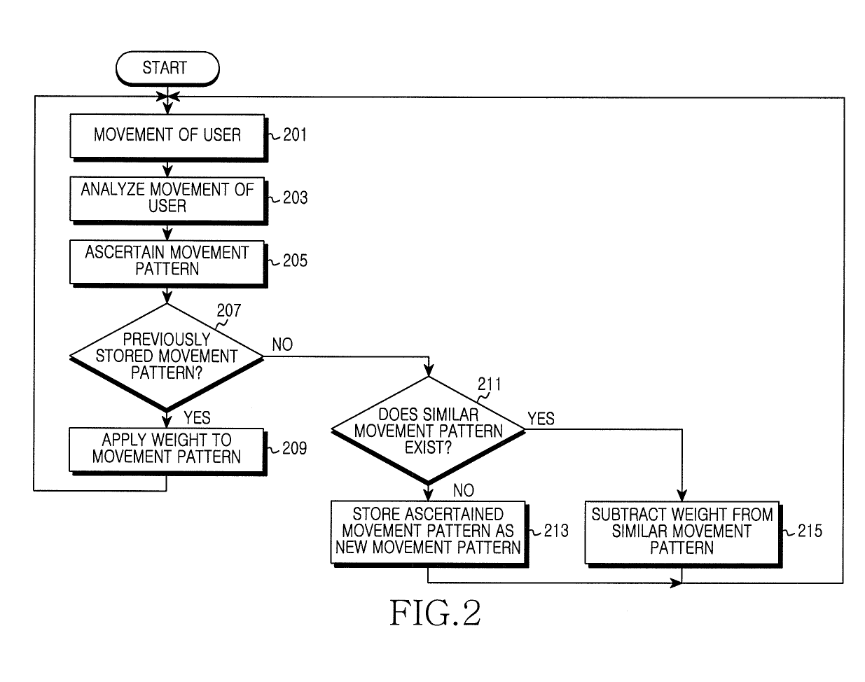

FIG. 2 illustrates a process of registering a movement pattern of a user in a portable terminal according to an embodiment of the present disclosure.

Referring to FIG. 2, the portable terminal is moved by a user (together with the user) in block 201. The portable terminal proceeds to block 203 and analyzes movement of the user. Herein, the portable terminal verifies whether a serving cell is changed through cell reselection and analyzes the movement of the user. When the serving cell is changed, the portable terminal determines that the user was moved.

The portable terminal proceeds to block 205 and ascertains a movement pattern of the user.

Herein, the movement pattern means cells through which the user of the portable terminal passes. The portable terminal ascertains the movement pattern of the user who is moved to a destination cell in which the user stays during a certain time. For example, when the user of the portable terminal stays in a cell C after being moved from a cell A and passing through a cell B, the portable terminal may verify a movement pattern of the user who is moved from cell A to cell C through cell B, that is cell A→cell B→cell C.

The portable terminal proceeds to block 207 and verifies whether the movement pattern of the user, which is ascertained in block 205, is substantially identical to a previously stored movement pattern. That is, the portable terminal verifies whether the user moved on the same path.

If the movement pattern of the user is substantially identical to the previously stored movement pattern in block 207, the portable terminal proceeds to block 209 and applies a weight to the previously stored movement pattern, that is, the movement pattern ascertained in block 205. Herein, the weight applied to the movement pattern signifies frequency in which the movement pattern of the user is generated. The more weights are applied, the more frequent it is indicated that the portable terminal is in movement to a path corresponding to the movement pattern.

The portable terminal proceeds to block 201 and repeatedly performs the process of ascertaining the movement pattern of the user.

Alternatively, if the ascertained movement pattern of the user is not identical to the previously stored movement pattern in block 207, the portable terminal proceeds to block 211 and verifies whether a similar movement pattern exists. Herein, the similar movement pattern is a pattern including a part of a path corresponding to the ascertained movement pattern of the user and may be a pattern in which an intermediate path except for a destination cell is identical.

If a similar movement pattern does not exist in block 211, the portable terminal proceeds to block 213 and stores the ascertained movement pattern of the user as a new movement pattern of the user.

Alternatively, if a similar movement pattern exists in block 211, the portable terminal proceeds to block 215 and subtracts a weight from the similar movement pattern. As it is possible for the user of the portable terminal not to move to a destination cell which is the final destination and move to a different cell, frequency in which the movement pattern of the user is generated is reduced.

After the portable terminal performs the processing of blocks 213 and 215, the portable terminal proceeds to block 201 and repeatedly performs the process of ascertaining the movement pattern of the user.

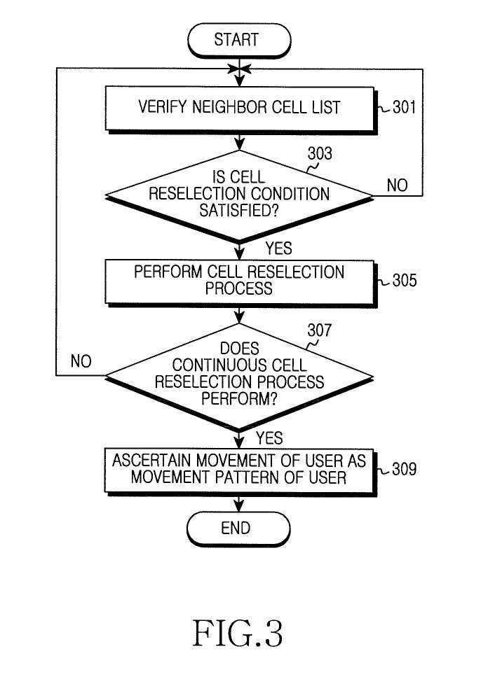

FIG. 3 illustrates a process of ascertaining a movement pattern of a user in a portable terminal according to one embodiment of the present disclosure.

Referring to FIG. 3, the process of ascertaining the movement pattern of the user signifies the processing of block 205 in FIG. 2. The portable terminal verifies a neighbor cell list in block 301.

The portable terminal proceeds to block 303 and verifies whether a cell reselection condition is satisfied. Herein, the portable terminal verifies whether a condition of a neighbor cell is better than that of a current cell.

If the cell reselection condition is not satisfied, the portable terminal performs the processing of block 301 again.

Alternatively, if the cell reselection condition is satisfied, the portable terminal proceeds to block 305 and performs a cell reselection process. The portable terminal proceeds to block 307 and verifies whether to perform a continuous cell reselection process. Herein, the continuous cell reselection process is defined as a process of staying in a destination cell over two or more neighbor cells included in neighbor cells within a certain time.

If the continuous cell reselection process is not performed in block 307, the portable terminal proceeds to block 301 and repeatedly performs the process of ascertaining the movement pattern of the user.

Alternatively, if the continuous cell reselection process is performed in block 307, the portable terminal proceeds to block 309 and ascertains the movement of the user as the movement pattern of the user.

Thereafter, the algorithm of FIG. 3 is ended.

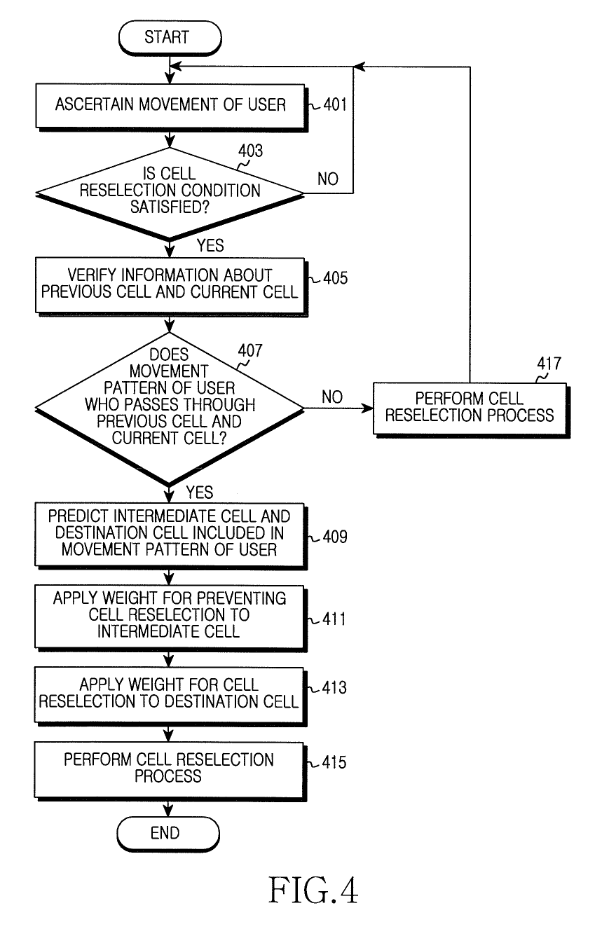

FIG. 4 illustrates a cell reselection process of a portable terminal according to the present disclosure.

Referring to FIG. 4, if the portable terminal verifies a movement pattern of a user who passes through an unnecessary place, it performs cell reselection to a destination cell immediately without passing through the place.

The portable terminal for performing the aforementioned cell reselection process ascertains the movement of the user in block 401. The portable terminal proceeds to block 403 and verifies whether a cell reselection condition is satisfied.

If the cell reselection condition is not satisfied in block 403, the portable terminal performs the processing of block 401 again.

Alternatively, if the cell reselection condition is satisfied in block 403, the portable terminal proceeds to block 405 and verifies information about a previous cell and a current cell. Herein, the portable terminal verifies information of a cell where it is positioned previously and a cell where it is positioned currently.

The portable terminal proceeds to block 407 and verifies whether a movement pattern of the user who passes through the previous cell and the current cell exists.

If a movement pattern of the user who passes through the previous cell and the current cell does not exist, the portable terminal proceeds to block 417 and performs a cell reselection process to the cell to which it is moved currently.

Alternatively, if the movement pattern of the user who passes through the previous cell and the current cell exists, the portable terminal proceeds to block 409 and predicts an intermediate cell and a destination cell which are included in the movement pattern of the user. Herein, the intermediate cell means a cell through which the user of the portable terminal passes before moving to the destination cell.

The portable terminal proceeds to block 411 and applies a weight to a cell reselection parameter for preventing cell reselection to the intermediate cell. The portable terminal proceeds to block 413 and applies a weight to a cell reselection parameter for performing cell reselection to the destination cell. Therefore, the portable terminal adjusts the cell reselection parameters of the intermediate cell and the destination cell using the weight to perform the cell reselection immediately to the destination cell without passing through the intermediate cell.

The portable terminal proceeds to block 415 and performs the cell reselection process. That is, the portable terminal performs cell reselection to the destination cell instead of cell reselection to the intermediate cell by applying the weight in blocks 409 to 413.

That is, if a pattern which is the same as a movement pattern of the user who currently moves is stored, the portable terminal ascertains a destination cell for the movement pattern, omits an unnecessary process of performing cell reselection to an intermediate cell, and performs cell reselection to the destination cell immediately. For example, if the portable terminal ascertains that the user moves from cell A to cell C through cell B, that is cell A→cell B→cell C, in a state where a movement pattern in which the user moves from cell A to cell E through cells B, C, and D, that is cell A→cell B→cell C→cell D→cell E, is stored, the portable terminal may ascertain that an intermediate cell is cell D and a destination cell is cell E. That is, the portable terminal ascertains that unnecessary cell reselection was performed with respect to movement from cell B to cell D through cell C, that is cell B→cell C→cell D, and performs cell reselection process to the destination cell E immediately, without performing cell reselection to the intermediate cell D.

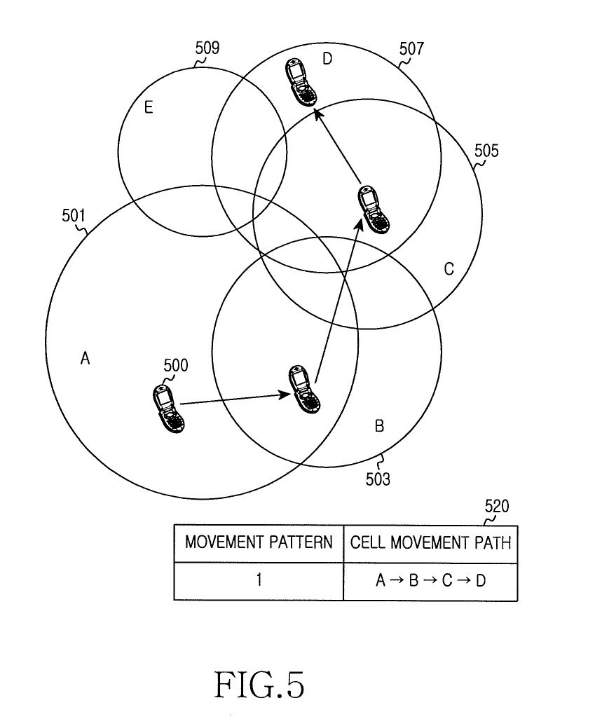

FIG. 5 illustrates a process of registering a movement pattern of a user in a portable terminal according to one embodiment of the present disclosure.

Referring to FIG. 5, if the portable terminal denoted by 500 is positioned in a cell A 501, the portable terminal verifies a cell B 503, a cell C 505, a cell D 507, and a cell E 509 on a neighbor cell list.

If the portable terminal 500 is moved to an area of cell B 503, it ascertains that a signal of cell B 503 is strong through a cell reselection parameter (Received Signal Strength Indicator (RSSI)) and performs a cell reselection process to cell B 503.

If the portable terminal is positioned in cell D 507 over cell C 505, it performs a cell reselection process from cell B 503 to cell C 505 and performs a cell reselection process from cell C 505 to cell D 507.

After the portable terminal 500 performs the aforementioned movement, it ascertains a movement pattern in which the user of the portable terminal 500 successively moves from cell A 501 to cell D 507.

That is, the portable terminal 500 stores the movement pattern of the user, which indicates a cell movement path 520 of the user.

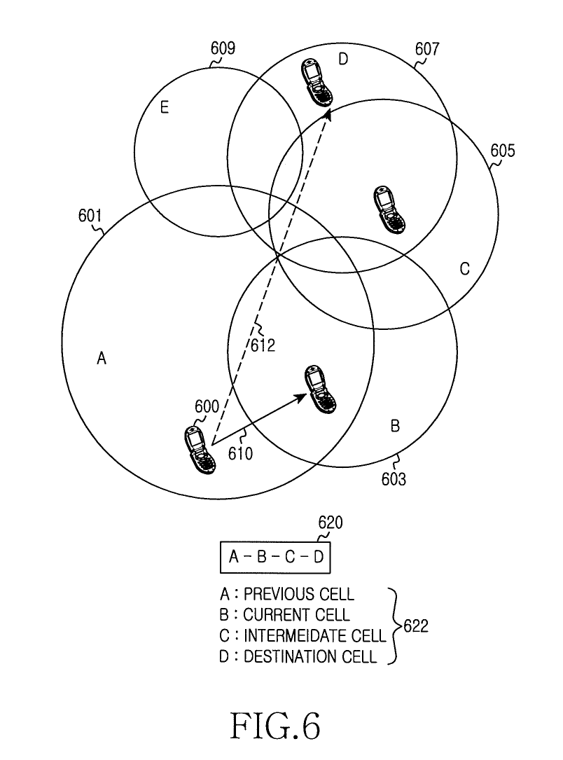

FIG. 6 illustrates a process of performing cell reselection to a destination cell without passing through an unnecessary intermediate cell in a portable terminal according to one embodiment of the present disclosure.

Referring to FIG. 6, assuming that the portable terminal denoted by 600 ascertains and stores the movement pattern of the user, as shown in FIG. 5, a description will be given.

The portable terminal 600 has performed cell reselection to a cell D 607 which is a destination cell over a cell B 603 and a cell C 605 included on a neighbor cell list after being positioned in a cell A 601.

For this reason, if the portable terminal 600 is moved from cell A 601 to cell B 603, that is if it is moved along an arrow 610, the portable terminal verifies a movement pattern of the user, in which cell A 601 and cell B 603 are included, among previously stored movement patterns of the user.

If the portable terminal senses a movement pattern 620 in which the user moves to cell D 607 over cell A 601, cell B 603, and cell C 605 among the previously stored movement patterns of the user, the portable terminal predicts that the user will move to the destination cell D 607 over the cell C 605, that is the user will move along an arrow 612.

The portable terminal 600 analyzes the verified movement pattern of the user and verifies information 622 about a previous cell, a current cell, an intermediate cell, and a destination cell. Herein, the portable terminal 600 predicts that the destination cell is cell D 607 using the previous cell and the current cell and determines cell C 605, which is the intermediate cell, as an unnecessary cell through which the user passes briefly.

The portable terminal 600 applies a weight to a cell reselection parameter to perform cell reselection to cell D 607 which is the destination cell immediately without performing cell reselection to the unnecessary cell C 605.

For this reason, the portable terminal 600 omits a cell reselection process to cell C 605 and performs a cell reselection process from cell B 603 to cell D 607.

That is, the portable terminal 600 applies a weight according to a movement pattern of the user to a cell reselection criterion parameter C2 and performs cell reselection to the destination cell.

That is, the portable terminal 600 applies the weight for the movement pattern of the user to cell D and recognizes cell D as a cell which is better than cell C.

A cell reselection parameter to which the weight is applied may be calculated using Equation (1) below.

RLA_C(W)=Measured RSSI+PatternWeight [Eqn. 1]

Herein, RLA_C(W) denotes Receive Level Average Cell Power (RSSI) to which a weight according to a movement pattern of the user is applied. PatternWeight denotes the weight applied according to the movement pattern of the user.

The portable terminal 600 may perform a cell reselection process to the destination cell using a general formula for calculating a path loss criterion parameter C1 and a cell reselection criterion parameter C2 using an RLA_C according to the RLA_C(W).

Also, the portable terminal 600 applies a weight to Qmeas,n which denotes quality (Received Signal Code Power (RSCP) or the Energy per Chip over the Internface noise (Edlo)) of a neighbor cell among cell reselection parameters of a 3G network, calculates a ranking of the neighbor cell, and may perform a cell reselection process to the destination cell. The ranking of the neighbor cell may be denoted using Equation (2) below.

Rn=Qmeas,n(W)−Qoffsets,n−T0n*(1−Ln) [Eqn. 2]

Herein, Rn denotes the ranking of the neighbor cell to which a weight is applied, and Qmeas,n(W) denotes the quality of the neighbor cell to which the weight is applied. The rest of parameters are the same as well-known parameters.

As described above, the present disclosure prevents a cell reselection process to an unnecessary cell. The prevent disclosure may reduce power consumption through an unnecessary cell reselection process by analyzing a movement pattern of a user, ascertaining information about a destination cell and information about an intermediate cell through which the user passes before moving to the destination cell, and preventing a cell reselection process to the intermediate cell.

While the present disclosure has been particularly shown and described with reference to exemplary embodiments thereof, it will be understood by those skilled in the art that various changes in form and details may be made therein without departing from the spirit and scope of the present disclosure as defined by the appended claims.

What is claimed is:

1. An apparatus for performing cell reselection in a portable terminal, the apparatus comprising:
a pattern management: unit configured to analyze movement of a user and ascertain a movement pattern of the user;
a memory configured to store the movement pattern of the user, which is ascertained by the pattern management unit;
a controller configured to ascertain information about a destination cell and information about an intermediate cell through which the user passes before moving to the destination cell using the movement pattern of the user and a current movement path of the portable terminal; and
a cell reselection unit configured to perform a cell reselection process to the destination cell, wherein the controller applies a weight to a cell reselection parameter to prevent cell reselection to the intermediate cell and performs the cell reselection process to the destination cell.

2. The apparatus of claim 1, wherein the pattern management unit is configured to verify whether the user passes through two or more neighbor cells included on a neighbor cell list within a certain time and stays in the destination cell and ascertain the movement pattern of the user.

3. The apparatus of claim 1, wherein, when a movement pattern of the same user is repeatedly ascertained, the pattern management unit applies a weight to the ascertained movement pattern of the user to signify that the user moves frequently on a path corresponding to the movement pattern.

4. The apparatus of claim 1, wherein the controller is configured to apply a weight to a ranking of a neighbor cell to prevent cell reselection to the intermediate cell.

5. The apparatus of claim 4, wherein the controller is configured to apply a weight to a parameter indicating a quality of a neighbor cell among cell reselection parameters.

6. The apparatus of claim 2, wherein the controller is configured to apply a weight to a ranking of a neighbor cell to prevent cell reselection to the intermediate cell.

7. The apparatus of claim 5, wherein the cell reselection is calculated according to the equation
RLA_C(W)=Measured RSSI+PatternWeight
where RLA_C(W) denotes a Receive Level Average Cell Power to which the weight is applied, and PatternWeight denotes the weight applied according to the movement pattern of the user.

8. The apparatus of claim 5, wherein the ranking of the neighbor cell is denoted according to the equation
Rn=Qmeas,n(W)−Qoffsets,n−T0n*(1−Ln)
where Rn denotes the ranking of the neighbor cell to which a weight is applied, and Qmeas,n(W) denotes the quality of the neighbor cell to which the weight is applied.

9. The apparatus of claim 1, wherein the destination cell and intermediate cell are part of a Public Land Mobile Network (PLMN).

10. The apparatus of claim 1, wherein the portable terminal further comprises an input unit, a display unit, and a communication unit.

11. A method of performing cell reselection in a portable terminal, the method comprising:
analyzing movement of a user and ascertaining a movement pattern of the user;
storing the ascertained movement pattern of the user;
ascertaining information about a destination cell and information about an intermediate cell through which the user passes before moving to the destination cell using the movement pattern of the user and a current movement path of the portable terminal; and
performing a cell reselection process to the destination cell, wherein the performance of the cell reselection process to the destination cell comprises applying a weight to a cell reselection parameter to prevent cell reselection to the intermediate cell.

12. The method of claim 11, wherein the ascertainment of the movement pattern of the user comprises verifying whether the user passes through two or more neighbor cells included on a neighbor cell list within a certain time and stays in the destination cell.

13. The method of claim 11, wherein the ascertainment of the movement pattern of the user comprises, when a movement pattern of the same user is repeatedly ascertained, applying a weight to the ascertained movement pattern of the user to signify that the user moves frequently on a path corresponding to the movement pattern.

14. The method of claim 11, wherein the performance of the cell reselection process to the destination comprises applying a weight to a ranking of a neighbor cell to prevent cell reselection to the intermediate cell.

15. The method of claim 14, wherein the application of the weight to the ranking of the neighbor cell comprises applying a weight to a parameter indicating quality of a neighbor cell among cell reselection parameters.

16. The method of claim 12, wherein the performance of the cell reselection process to the destination comprises applying a weight to a ranking of a neighbor cell to prevent cell reselection to the intermediate cell.

17. The method of claim 15, wherein the cell reselection is calculated according to the equation
RLA_C(W)=Measured RSSI+PatternWeight
where RLA_C(W) denotes a Receive Level Average Cell Power to which the weight is applied, and PatternWeight denotes the weight applied according to the movement pattern of the user.

18. The method of claim 15, wherein the ranking of the neighbor cell is denoted according to the equation
Rn=Qmeas,n(W)−Qoffsets,n−T0n*(1−Ln)
where Rn denotes the ranking of the neighbor cell to which a weight is applied, and Qmeas,n(W) denotes the quality of the neighbor cell to which the weight is applied.

19. The method of claim 11, wherein the destination cell and intermediate cell are part of a Public Land Mobile Network (PLMN).

20. The method of claim 11, wherein the portable terminal comprises an input unit, a display unit, and a communication unit.
